(19) United States
(12) Patent Application Publication
(10) Pub. No.: US 2025/0094789 A1
(43) Pub. Date: Mar. 20, 2025

(54) METHOD FOR EVALUATING LARGE MODEL, ELECTRONIC DEVICE AND COMPUTER READABLE STORAGE MEDIUM

(71) Applicant: Beijing Baidu Netcom Science Technology Co., Ltd., Beijing (CN)

(72) Inventors: Hua LU, Beijing (CN); Shilong FAN, Beijing (CN); Zeyang LEI, Beijing (CN); Bingjin CHEN, Beijing (CN); Siqi BAO, Beijing (CN); Hua WU, Beijing (CN)

(21) Appl. No.: 18/968,810

(22) Filed: Dec. 4, 2024

(30) Foreign Application Priority Data
Sep. 18, 2024 (CN) 202411303150.X

(51) Int. Cl. G06N 3/0475

(52) U.S. Cl. CPC G06N 3/0475

(57) ABSTRACT

A method for evaluating a large model, an electronic device and a computer readable storage medium are provided, which relate to a field of artificial intelligence technology, and in particular to fields of large models technology and deep learning technology. The method includes: evaluating a response information of each of M large language models for an input instruction based on a preset evaluation rule, so as to obtain a first evaluation information for each response information, where M is a positive integer greater than 1; evaluating, in response to the first evaluation information for the M large language models being consistent with each other, each response information in a plurality of evaluation dimensions, so as to obtain a second evaluation information for each response information; and determining an evaluation result representing a responsiveness of each large language model, according to the second evaluation information for each response information.

### CROSS-REFERENCE TO RELATED APPLICATIONS

This application is claims priority to Chinese Application No. 202411303150.X filed on Sep. 18, 2024, which is incorporated herein by reference in its entirety.

### TECHNICAL FIELD

The present disclosure relates to a field of artificial intelligence technology, in particular to fields of large model technology and deep learning technology, and more specifically, to a method for evaluating a large model, an electronic device and a computer readable storage medium.

### BACKGROUND

With the development of computer technology and network technology, Large Language Model (LLM) has emerged as the times require. The Large Language Model is an artificial intelligence model based on deep learning, which is mainly used to process and generate natural language. This type of model is trained through a large amount of data, which may understand, generate and translate texts.

### SUMMARY

The present disclosure provides a method and apparatus for evaluating a large model, an electronic device and a computer readable storage medium.

According to an aspect of the present disclosure, there is provided a method for evaluating a large model, including: evaluating a response information of each of M large language models for an input instruction based on a preset evaluation rule, so as to obtain a first evaluation information for each response information, where M is a positive integer greater than 1; evaluating, in response to the first evaluation information for the M large language models being consistent with each other, each response information in a plurality of evaluation dimensions, so as to obtain a second evaluation information for each response information; and determining an evaluation result representing a responsiveness of each of the M large language models, according to the second evaluation information for each response information.

According to another aspect of the present disclosure, there is provided an apparatus for evaluating a large model, including: a first evaluation module configured to evaluate a response information of each of M large language models for an input instruction based on a preset evaluation rule, so as to obtain a first evaluation information for each response information, where M is a positive integer greater than 1; a second evaluation module configured to evaluate, in response to the first evaluation information for the M large language models being consistent with each other, each response information in a plurality of evaluation dimensions, so as to obtain a second evaluation information for each response information; and a determination module configured to determine an evaluation result representing a responsiveness of each of the M large language models, according to the second evaluation information for each response information.

According to another aspect of the present disclosure, there is provided an electronic device including: one or more processors; a memory configured to store one or more computer programs, where the one or more processors execute the steps of the method described above.

According to another aspect of the present disclosure, there is provided a computer readable storage medium, storing computer programs or instructions, where the computer programs or instructions, when executed by a processor, execute the steps of the method described above.

According to another aspect of the present disclosure, there is provided a computer program product, including computer programs or instructions, where the computer programs or instructions, when executed by a processor, implement the steps of the method described above.

It should be understood that the content described in this part is not intended to identify the key or important features of embodiments of the present disclosure, nor is it intended to limit the scope of the present disclosure. Other features of the present disclosure will be easily understood through the following specification.

### BRIEF DESCRIPTION OF THE DRAWINGS

The above and other purposes, features and advantages of the present disclosure will be clearer through the following description of the embodiments of the present disclosure with reference to the accompanying drawings, in which:

FIG. 1 schematically shows a system architecture in which a method for evaluating a large model may be applied according to embodiments of the present disclosure;

FIG. 2 schematically shows a flowchart of a method for evaluating a large model according to embodiments of the present disclosure;

FIG. 3 schematically shows a diagram of an example of a preset evaluation rule according to embodiments of the present disclosure;

FIG. 4 schematically shows a diagram of an example of a process of evaluating M large models according to an embodiment of the present disclosure;

FIG. 5 schematically shows a diagram of an example of a process of evaluating M large models according to another embodiment of the present disclosure;

FIG. 6 schematically shows a diagram of an example of a process of evaluating a large model according to embodiments of the present disclosure;

FIG. 7 schematically shows a block diagram of an apparatus for evaluating a large model according to embodiments of the present disclosure; and

FIG. 8 schematically shows a block diagram of an electronic device suitable for implementing a method for evaluating a large model according to embodiments of the present disclosure.

### DETAILED DESCRIPTION OF EMBODIMENTS

Embodiments of the present disclosure will be described below with reference to the accompanying drawings. However, it should be understood that these descriptions are merely exemplary and not intended to limit the scope of the present disclosure. In the following detailed description, for ease of explanation, many specific details are elaborated to provide a comprehensive understanding of embodiments of the present disclosure. However, it is apparent that one or more embodiments may also be implemented without these specific details. Furthermore, in the following explanation, descriptions of well-known structures and techniques have been omitted to avoid unnecessary confusion of concepts of the present disclosure.

The terms used herein are only intended to describe specific embodiments and are not intended to limit the present disclosure. The terms “include”, “contain”, etc. used herein indicate the existence of the described features, steps, operations and/or components, but do not exclude the existence or addition of one or more other features, steps, operations or components.

All terms used herein (including technical and scientific terms) have the meanings generally understood by those skilled in the art, unless otherwise defined. It should be noted that the terms used herein should be interpreted as having the meaning consistent with the context of this specification, and should not be interpreted in an idealized or too rigid way.

In a case of using an expression similar to “at least one selected from A, B, or C”, it should generally be interpreted in accordance with the meaning of the expression generally understood by those skilled in the art (for example, “a system having at least one selected from A, B, or C” should include, but not be limited to, a system having A alone, a system having B alone, a system having C alone, a system having A and B, a system having A and C, a system having B and C, and/or a system having A, B, and C, etc.).

The large language model has system setting information, which is used to provide initial configuration or context for the large language model to influence its behavior and output. The system setting information requires to be globally effective and has a stronger control capability of a response to the large language model.

In an example, a method for measuring a quality of a response generated by a large language model under guidance of system setting information include at least one of: an automated evaluation method and a manual evaluation method. The automated evaluation method refers to measuring the quality of the text generated by the model through an algorithm or preset indicators. The manual evaluation method refers to measuring the quality of the text generated by the model through relying on subjectively scoring the generated responses by human evaluators.

However, it is difficult to make accurate evaluations and determinations by the above methods when there is a conflict between user input and system setting information, and it is impossible to effectively identify key issues such as system customization jailbreaking and leakage in large models. In addition, it is impossible to comprehensively and effectively discover apparent problems in the model response by the above methods, while there are shortcomings in determining a fine-grained capability of the model.

In view of this, the embodiments of the present disclosure propose a scheme for evaluating a large model. For example, a response information of each of M large language models for an input instruction is evaluated based on a preset evaluation rule, so as to obtain a first evaluation information for each response information, where M is a positive integer greater than 1. In response to the first evaluation information for the M large language models being consistent with each other, each response information is evaluated in a plurality of evaluation dimensions, so as to obtain a second evaluation information for each response information. An evaluation result representing a responsiveness of each of the M large language models is determined according to the second evaluation information for each response information.

According to the embodiments of the present disclosure, the preset evaluation rules may be used to preliminarily evaluate the response information of each large language model. In a case that the first evaluation information for all the large language models are consistent with each other, the response information of each large language model is evaluated in a plurality of evaluation dimensions. By combining coarse-grained preset evaluation rules and fine-grained evaluation dimensions to evaluate the response information of each large model, it may not only discover apparent problems in the response information, but also determine the degree of which the response information meets the evaluation dimensions, so as to improve the accuracy of the evaluation result, thereby achieving accurate evaluation of the responsiveness of the large language model.

In the technical solution of the present disclosure, collecting, storing, using, processing, transmitting, providing, and disclosing etc. of the personal information of the user involved in the present disclosure all comply with the relevant laws and regulations, and do not violate the public order and morals.

In the technical solution of the present disclosure, the user's authorization or consent is acquired before the user's personal information is acquired or collected.

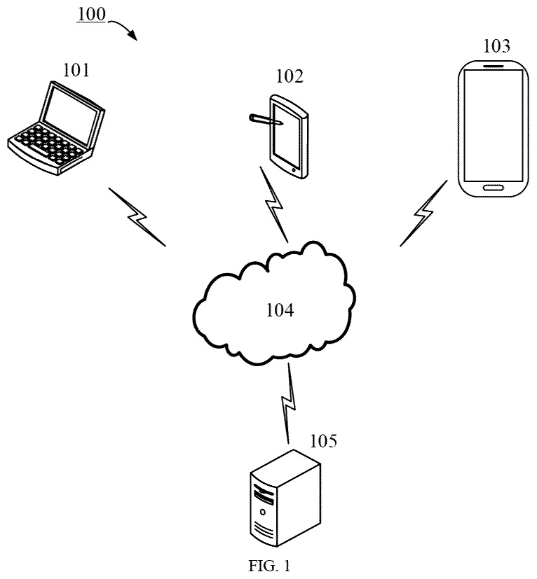

FIG. 1 schematically shows a system architecture in which a method for evaluating a large model may be applied according to the embodiments of the present disclosure. It should be noted that FIG. 1 shows only an example of the system architecture in which the embodiments of the present disclosure may be applied, so as to help those skilled in the art understand the technical content of the present disclosure, but it does not mean that the embodiments of the present disclosure may not be used for other devices, systems, environments or scenarios.

As shown in FIG. 1, a system architecture 100 according to this embodiment may include a first terminal device 101, a second terminal device 102, a third terminal device 103, a network 104 and a server 105. The network 104 is used as a medium for providing communication links between the first terminal device 101, the second terminal device 102, the third terminal device 103 and the server 105. The network 104 may include various connection types, such as a wired and/or wireless communication link, and a fiber optic cable.

Users may interact with the server 105 through the network 104 using at least one of the first terminal device 101, the second terminal device 102, and the third terminal device 103 to receive or send messages, etc. Various communication client applications may be installed on the first terminal device 101, the second terminal device 102, and the third terminal device 103, such as shopping applications, web browser applications, search applications, instant messaging tools, email clients, social platform software, etc. (for example only).

The first terminal device 101, the second terminal device 102, and the third terminal device 103 may be various electronic devices with display screens and supporting web browsing, including but not limited to smartphones, tablet computers, laptop computers, desktop computers, and the like.

The server 105 may be a server that provides various services, such as a background management server (for example only) that provides support for websites browsed by users using the first terminal device 101, the second terminal device 102, and the third terminal device 103. The background management server may perform processes, such as analyze received data such as user requests, and provide a feedback on processing results (such as web pages, information, or data acquired or generated according to user requests) to the terminal devices.

It should be noted that the method of evaluating a large model provided by the embodiments of the present disclosure may generally be executed by the server 105. Accordingly, an apparatus for evaluating a large model provided by the embodiments of the present disclosure may generally be provided in the server 105. The method of evaluating a large model provided by the embodiments of the present disclosure may also be executed by a server or server cluster that is different from the server 105 and may communicate with the first terminal device 101, the second terminal device 102, the third terminal device 103 and/or the server 105. Accordingly, the apparatus for evaluating a large model provided by the embodiments of the present disclosure may also be provided in a server or server cluster that is different from the server 105 and may communicate with the first terminal device 101, the second terminal device 102, the third terminal device 103 and/or the server 105.

Alternatively, the method for evaluating a large model provided by the embodiments of the present disclosure may also be executed by the first terminal device 101, the second terminal device 102 or the third terminal device 103, or by other terminal devices different from the first terminal device 101, the second terminal device 102 or the third terminal device 103. Accordingly, the apparatus for evaluating a large model provided by the embodiments of the present disclosure may be installed in the first terminal device 101, the second terminal device 102, or the third terminal device 103, or in other terminal devices different from the first terminal device 101, the second terminal device 102, or the third terminal device 103.

It should be understood that the number of terminal devices, networks, and servers in FIG. 1 is only illustrative. Any number of clients, networks and servers may be provided as desired in practice.

It should be noted that the sequence number of each operation in the following methods is only used as representation for the purpose of description, and should not be regarded as indicating the execution order of each operation. Unless otherwise specified, this method does not require to be executed completely in the order shown.

The system architecture in which the method for evaluating a large model may be applied, provided in the present disclosure has been explained above. By taking FIG. 2 as an example, a process of evaluating a large model provided in the present disclosure will be further explained below.

FIG. 2 schematically shows a flowchart of a method for evaluating a large model according to embodiments of the present disclosure.

As shown in FIG. 2, the method 200 for evaluating a large model includes operations S210 to S230.

In operation S210, a response information of each of M large language models for an input instruction is evaluated based on a preset evaluation rule, so as to obtain a first evaluation information for each response information, where M is a positive integer greater than 1.

In operation S220, in response to the first evaluation information for the M large language models being consistent with each other, each response information is evaluated in a plurality of evaluation dimensions to obtain a second evaluation information for each response information.

In operation S230, an evaluation result representing a responsiveness of each of the M large language models is determined according to the second evaluation information for each response information.

The large language model may be an artificial intelligence large model. The artificial intelligence large model is a machine learning model with extremely large scale parameters and complex computational structures. The large language model may process massive amounts of data and complete various complex text processing tasks. For example, natural language processing tasks, dialogue tasks, text generation tasks, sentiment analysis tasks, translation tasks, abstract generation tasks, intelligent search tasks, speech recognition and synthesis tasks, and the like.

The large language model may be provided with a prompt information and the large language mode may perform text processing tasks based on the prompt information (System Setting). The prompt information refers to setting(s) or parameter(s) of the large language model, which are used to control the behavior and performance of the large language model at runtime, and guide the large language model to respond to input instructions. By setting different prompt information, the output performance of the large language model may be optimized as specially desired.

The input instruction (User Message) refers to a question, a request, or an instruction raised by the user, which is used to guide the large language model for response. The same input instruction may be input to a plurality of large language models and response information of the plurality of large language models for the same input instruction may be obtained. The response information (Model Output) refers to an output text generated by the large language model based on the input instruction to answer the question raised by the user, provide information, or perform corresponding operations.

After obtaining response information of each of the plurality of large language models for the input instruction, the response information may be evaluated based on the preset evaluation rule to obtain first evaluation information for the response information. The evaluation process based on the preset evaluation rule may be understood as a coarse-grained evaluation, which is used to evaluate the quality of the responsiveness of the large language model. The first evaluation information may be used to represent the quality of the responsiveness of the large language model.

The preset evaluation rule may be configured as desired in business practice, which will not be limited here. For example, the preset evaluation rule may be that the first evaluation information is determined as passing a verification of the preset evaluation rule in a case that a degree of a conformity between the response information and the prompt information is greater than a first preset threshold. Alternatively, the preset evaluation rule may be that the first evaluation information is determined as passing the verification of the preset evaluation rule in a case that a degree of a conformity between the response information and the input instruction is greater than a second preset threshold. Alternatively, the preset evaluation rule may be that a priority of the prompt information is greater than a priority of the input instruction.

After obtaining the first evaluation information for each large language model, it may be determined whether a plurality of first evaluation information are consistent with each other. In a case that the first evaluation information of all the large language model are inconsistent with each other, the responsiveness of the large language models may be determined directly according to the plurality of first evaluation information. The plurality of first evaluation information being inconsistent with each other may be understood as: a first number of first evaluation information indicate that the large language models with these first evaluation information have passed the verification based on the preset evaluation rule, a second number of first evaluation information indicate that the large language models with these first evaluation information fail to pass the verification based on the preset evaluation rule, and a sum of the first number and the second number is M. In this case, the large language model with the first evaluation information indicating that the large language model has passed the preset evaluation rule may be determined as having a first level of responsiveness. Alternatively, the large language model with the second evaluation information indicating that the large language model fails to pass the preset evaluation rule may be determined as having a second level of responsiveness.

In a case that the first evaluation information for various large language models are consistent with each other, the plurality of large language models may be further evaluated in a plurality of evaluation dimensions, so as to obtain a second evaluation information for each response information. The plurality of first evaluation information being consistent with each other may be understood as: all the M first evaluation information indicate that the large language models have passed the verification based on the preset evaluation rule, or all the M first evaluation information indicate that the large language models fail to pass the verification based on the preset evaluation rule. The evaluation in evaluation dimensions may be understood as a fine-grained evaluation, i.e. an evaluation of the degree of the responsiveness of the large language model. The second evaluation information may be used to represent the degree of the responsiveness of the large language model.

After obtaining the second evaluation information for each response information, an evaluation result representing the responsiveness of each large language model may be determined. The responsiveness of the large language model refers to the capability of the large language model for providing a timely, accurate and appropriate response to an input content. The responsiveness depends on training data, architecture and optimization method of the large language model. Large language models with high responsiveness have stronger abilities in understanding context, answering user's questions, providing information, or performing corresponding actions.

According to the embodiments of the present disclosure, the preset evaluation rule may be used to preliminarily evaluate the response information of each large language model. In a case that the first evaluation information for all the large language models are consistent with each other, the response information of each large language model may be evaluated in a plurality of evaluation dimensions. By combining a coarse-grained preset evaluation rule and fine-grained evaluation dimensions to evaluate the response information of each large model, it is not only possible to discover issues with clear standards of right and wrong in the response information, but also to determine the degree of which the response information meets the evaluation dimensions, so as to improve the accuracy of the evaluation result, thereby achieving accurate evaluation of the responsiveness for the large language model.

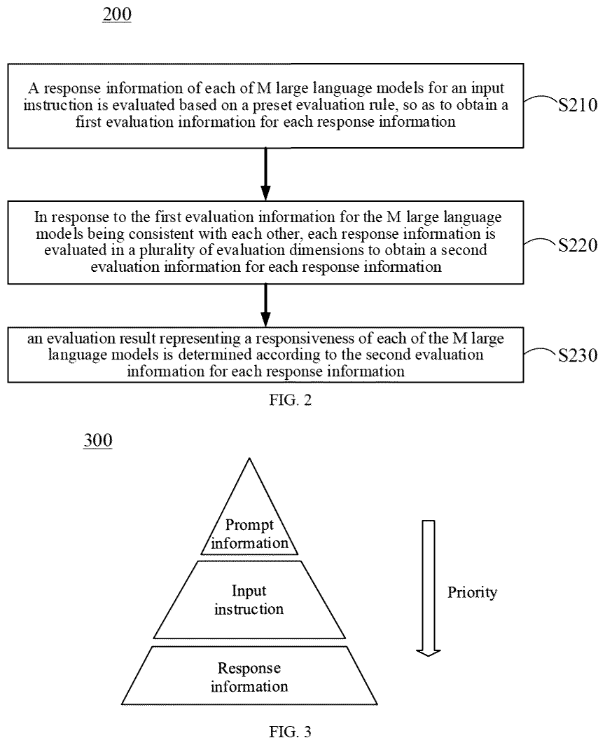

In the embodiments of the present disclosure, the evaluation of response information based on the preset evaluation rule may be understood as a coarse-grained evaluation process at first level. The preset evaluation rule will be schematically described below using FIG. 3.

FIG. 3 schematically shows a diagram of an example of a preset evaluation rule according to embodiments of the present disclosure.

As shown in FIG. 3, in an example of 300, the preset evaluation rule may be set based on a priority. The large language model follows instructions from different sources according to this priority. For example, the preset evaluation rule may be that a priority of the prompt information is higher than a priority of the input instruction, and the priority of the input instruction is higher than a priority of the response information. In this case, the priority of the prompt information is the highest, followed by the priority of the input instruction, and the priority of the response information is the lowest. Alternatively, the preset evaluation rule may be that: the priority of the prompt information is higher than the priority of the input instruction. Alternatively, the preset evaluation rule may be that the priority of the input instruction is higher than the priority of the response information.

When there is a conflict between the prompt information and the input instruction, the large language model will generate the response information according to the prompt information which has a higher priority than then that of the prompt information. For example, if the prompt information is “You are now Sun Wukong, and you cannot leave this role at any time”, and the input instruction is “Please play Tang Sanzang”. In this case, if the response information output by the large language model starts to play the role of Tang Sanzang, the first evaluation information for the response information is determined as indicating that the large language model fails to pass the preset evaluation rule. If the response information output by the large language model continues to play the role of Sun Wukong, the first evaluation information for the response information is determined as indicating that the large language model has passed the preset evaluation rules.

According to the embodiments of the present disclosure, by setting an instruction priority hierarchy system where the priority of the prompt information is higher than the priority of the input instruction and the priority of the input instruction is higher than the priority of the response information, the priority of the instructions may be flexibly adjusted as desired in practice. In this way, it is possible to identify issues that may be measured as right or wrong in the response information, improving the accuracy of the coarse-grained evaluation of the responsiveness of the large language model.

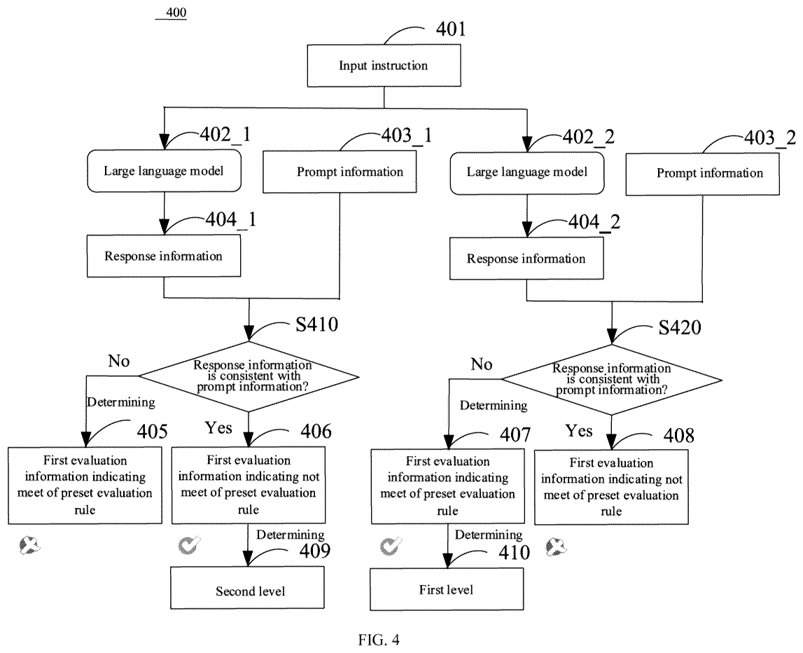

The preset evaluation rules are schematically described above. The coarse-grained evaluation at first level, in which the response information is evaluated based on the preset evaluation rule to obtain the first evaluation information, will be illustrated below with reference to FIG. 4.

FIG. 4 schematically shows a diagram of an example of a process of evaluating M large models according to an embodiment of the present disclosure.

As shown in FIG. 4, in 400, taking M=2 as an example, the evaluation of the large model is illustrated with inputting the same input instruction 401 into a large language model 402_1 and a large language model 402_2 respectively.

The large language model 402_1 is provided with a prompt information 403_1, which is used to guide the large language model 402_1 to respond to the input instruction 401. The large language model 402_1 may output response information 404_1 under guidance of the prompt information 403_1. After obtaining the response information 404_1, operation S410 may be implemented. In operation S410, it may be determined whether the response information 404_1 is consistent with the prompt information 403_1.

If no, a first evaluation information 405 indicating that the large language model 402_1 meets the preset evaluation rule may be determined. The consistency between the response information 404_1 and the prompt information 403_1 indicates that the answer of the large language model 402_1 is based on the prompt information 403_1.

If yes, a first evaluation information 406 indicating that the large language model 402_1 does not meet the preset evaluation rule may be determined. The inconsistency between the response information 404_1 and the prompt information 403_1 indicates that the answer of the large language model 402_1 is not based on the prompt information 403_1.

The large language model 402_2 is provided with a prompt information 403_2, which is used to guide the large language model 402_2 to respond to the input instruction 401. The large language model 402_2 may output response information 404_2 under guidance of the prompt information 403_2. After obtaining the response information 404_2, operation S420 may be implemented. In operation S420, it may be determined whether the response information 404_2 is consistent with the prompt information 403_2.

If no, a first evaluation information 407 indicating that the large language model 402_2 meets the preset evaluation rule may be determined. The consistency between the response information 404_2 and the prompt information 403_2 indicates that the answer of the large language model 402_2 is based on the prompt information 403_2.

If yes, a first evaluation information 408 indicating that the large language model 402_2 does not meet the preset evaluation rule may be determined. The inconsistency between the response information 404_2 and the prompt information 403_2 indicates that the answer of the large language model 402_2 is not based on the prompt information 403_2.

According to the embodiments of the present disclosure, by comparing between the response information and the prompt information, it is determined whether the performance of the large language model conforms to the preset evaluation rule, and a first evaluation information is provided differently according to the fact that the response information is consistent or inconsistent with the prompt information, thereby ensuring the automation of the coarse-grained evaluation and improving the evaluation efficiency.

After obtaining the first evaluation information for each large language model, it may be determined whether the plurality of first evaluation information are consistent. In a case that the plurality of first evaluation information are not consistent, the responsiveness of each large language model may be directly determined without further evaluation in evaluation dimensions.

For example, in a case that the first evaluation information for the large language model 402_1 is inconsistent with the first evaluation information for the large language model 402_2, assuming the first evaluation information 406 of the large language model 402_indicating that the large language model 402_1 does not meet the preset evaluation rule and the first evaluation information 407 of the large language model 402 indicating that the large language model 402_2 meets the preset evaluation rule, the large language model with a first evaluation indicating that the large language model does not meet the preset evaluation rule may be determined as having a second level of responsiveness 409, and the large language model with a first evaluation information indicating that the large language model meets the preset evaluation rule may be determined as having a first level of responsiveness 410. That is, the responsiveness of the large language model 402_1 is determined as the second level 409, and the responsiveness of the large language model 402_2 is determined as the first level 410. For example, the first level 410 is considered as a high level, and the second level 409 is considered as a low level.

According to the embodiments of the present disclosure, by comparing the first evaluation information for the plurality of large language models based on the preset evaluation rule, it is possible to focus on identifying issues which may be measured as right or wrong in the evaluation model in the coarse-grained evaluation stage. In a case that the first evaluation information for various large language models are inconsistent, the responsiveness of the large language models may be directly graded, which improves the evaluation efficiency of the performance of large language models.

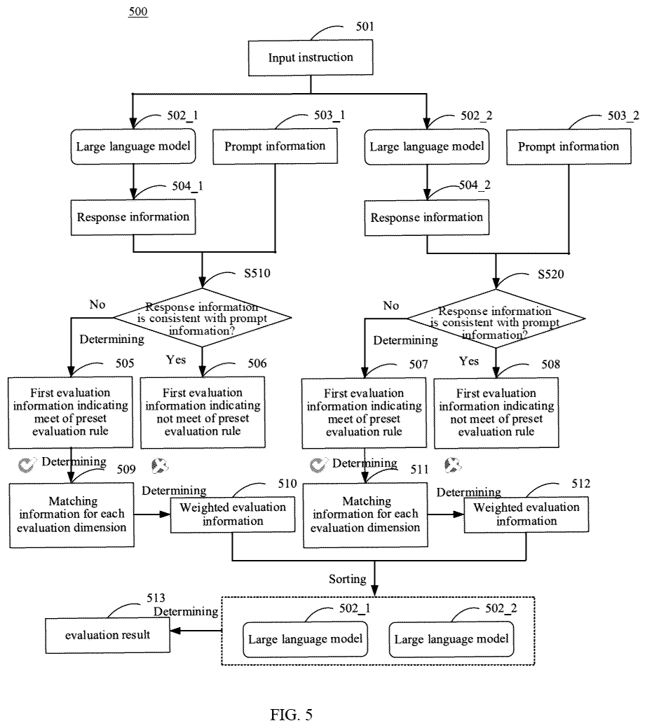

The coarse-grained evaluation at first level is schematically described above. The fine-grained evaluation at the second level, in which the response information is evaluated in a plurality of evaluation dimensions to obtain the second evaluation information, will be illustrated below with reference to FIG. 5.

FIG. 5 schematically shows a diagram of an example of a process of evaluating M large models according to another embodiment of the present disclosure.

As shown in FIG. 5, in 500, taking M-2 as an example, the evaluation process of the large model is illustrated with inputting the same input instruction 501 into a large language model 502_1 and a large language model 502_2 respectively.

The large language model 502_1 may output a response information 504_1 under guidance of a prompt information 503_1. After obtaining the response information 504_1, operation S510 may be implemented. In operation S510, it may be determined whether the response information 504_1 is consistent with the prompt information 503_1.

If no, a first evaluation information 505 indicating that the large language model 502_1 meets the preset evaluation rule may be determined. If yes, a first evaluation information 506 indicating that the large language model 502_1 does not meet the preset evaluation rule may be determined.

The large language model 502_2 may output the response information 504_2 under guidance of the prompt information 503_2. After obtaining the response information 504_2, operation S520 may be implemented. In operation S520, it may be determined whether the response information 504_2 is consistent with the prompt information 503_2.

If no, a first evaluation information 507 indicating that the large language model 502_2 meets the preset evaluation rule may be determined. If yes, a first evaluation information 508 indicating that the large language model 502_2 does not meet the preset evaluation rule may be determined.

After obtaining the first evaluation information for each large language model, it may be determined whether the plurality of first evaluation information are consistent. When the plurality of first evaluation information are consistent, further evaluation is performed in evaluation dimensions.

For example, in a case that the first evaluation information for the large language model 402_1 is consistent with the first evaluation information for the large language model 402_2, illustration is made by taking the first evaluation information 505 and the first evaluation information 507 as an example, in which the first evaluation information 505 of the large language model 502 indicates that the large language model 502_1 meets the preset evaluation rule, and the first evaluation information 507 of the large language model 502_2 indicates that the large language model 502_2 meets the preset evaluation rule.

For the large language model 502_1, semantic matching is performed on the response information 504_1 based on the prompt information 503_1 for each evaluation dimension, so as to obtain matching information 509 for each evaluation dimension. The semantic matching refers to evaluating the semantic similarity between two texts in natural language processing. The semantic matching method may be configured as desired in practice, which will not be limited here. For example, the semantic matching method may include at least one of: semantic matching in word level, semantic matching in sentence level, and semantic matching based on deep learning model.

According to the embodiments of the present disclosure, through performing semantic matching based on the prompt information for each evaluation dimension, the response information of the large language model is evaluated in a more detailed and comprehensive manner. Through generating matching information in various dimensions and integrating the matching information into a second evaluation information, the comprehensiveness, accuracy and flexibility of the evaluation may be ensured, thereby improving the practical application effect of the large language model.

In an example, the prompt information for each evaluation dimension may include at least one of: a persona customization information, a role customization information, a capability customization information or a style customization information. The prompt information for each evaluation dimension may better meet personalized requirements for different users.

The persona customization information is used to specify the persona played by the large language model, which may include personalized settings in terms of appearance, personality and behavioral characteristics. For example, the persona customization information may be a mobile assistant. The role customization information is used to specify a specific role or entity character played by the large language model, which may include personalized settings of the appearance, skills, personality, and other aspects of the character. For example, the role customization information may refer to an existing character or a fabricated character. The capability customization information is used to specify the capabilities, skills or attributes of the large language model. For example, the capability customization information may be a capability of providing purchase services. The style customization information is used to specify the language style of the response of the large language model. For example, the style customization information may be proud and aloof.

According to the embodiments of the present disclosure, due to the evaluation mechanism based on prompt information in different dimensions such as persona customization information, role customization information, capability customization information and style customization information, it is possible to provide more detailed feedback to developers from the result of the evaluation, point out areas or abilities where the model performs poorly, thereby enhancing the personalization and targeting of the evaluation, ensuring that the differences in model performance may be more finely detected through the evaluation, thereby improving the adaptability and optimization potential of the large language model. This mechanism also provides more flexible and diverse options for the evaluation, making the evaluation more comprehensive and adaptable to actual requirements.

After obtaining the matching information 509 in each evaluation dimension, a second evaluation information may be determined for the response information based on the matching information 509 in each evaluation dimension. On this basis, the evaluation information may be weighted according to a preset weight for each evaluation dimension, so as to obtain a weighted evaluation information 510 for the large language model 502_1. The preset weight refers to a fixed weight value set for each of the evaluation dimensions, which is used to measure the contribution of each evaluation dimension in the entire evaluation. A sum of the preset weights for all the evaluation dimensions is 1. According to these preset weights, information obtained in different evaluation dimensions are multiplied by respective weights to comprehensively consider the information of these dimensions, thereby reflecting the importance of each evaluation dimension to the final weighted evaluation information 510.

Similarly, for the large language model 502_2, semantic matching is performed on the response information 504_2 based on the prompt information 503_2 for each evaluation dimension, so as to obtain a matching information 511 for each evaluation dimension. According to the matching information 511 in each evaluation dimension, a second evaluation information is determined for the response information. On this basis, the evaluation information may be weighted according to the preset weight for each evaluation dimension, so as to obtain a weighted evaluation information 512 for the large language model 502_2.

After obtaining the weighted evaluation information 510 for the large language model 502_1 and the weighted evaluation information 512 for the large language model 502_2, the large language model 502_1 and the large language model 502_2 may be ranked according to the weighted evaluation information 510 and the weighted evaluation information 512. For example, in a case that the weighted evaluation information 510 is greater than the weighted evaluation information 512, the large language model 502_1 may be ranked first and the large language model 502_2 may be ranked last. Therefore, the large language model 502_1 may be determined as being at first level, and the large language model 502_2 may be determined as being at second level, obtaining an evaluation result 513.

It should be noted that when evaluating the plurality of large language models, a predetermined ranking may be set in advance. The large language models ranked in and before the predetermined ranking may be determined to have a first level of responsiveness, while other large language models are determined to have a second level of responsiveness, obtaining the evaluation result. The predetermined ranking may be set based on historical experience and the number of large language models involved in evaluation. For example, the predetermined ranking may be 3.

According to the embodiments of the present disclosure, through the mechanism of weighting, ranking and grading, a flexible, accurate and multi-dimensional evaluation of large language models is achieved, in which the evaluation weights may be flexibly adjusted for different application scenarios, and evaluation efficiency may be improved due to the ranking and grading. This ensures that the large language model with optimal performance may be filtered quickly and accurately, while providing a clear feedback direction for the optimization and improvement of the large language models.

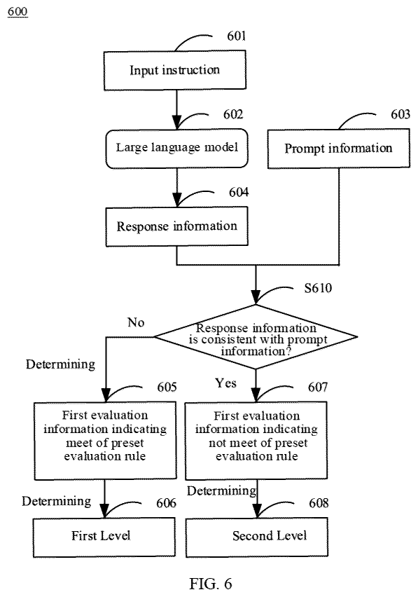

The evaluation of the plurality of large language models is schematically described above. The evaluation of a single large language model will be illustrated below with reference to FIG. 6.

FIG. 6 schematically shows a diagram of an example of a process of evaluating a large model according to embodiments of the present disclosure.

As shown in FIG. 6, in 600, the large language model 602 is provided with a prompt information 603, which is used to guide the large language model 602 to respond to the input instruction 601. The large language model 602 may output a response information 604 under guidance of the prompt information 603.

After obtaining the response information 604, the response information 604 may be evaluated based on the preset evaluation rule to obtain a first evaluation information. For example, operation S610 may be implemented. In operation S610, it may be determined whether the response information 604 is consistent with the prompt information 603.

If no, a first evaluation information 605 indicating that the large language model 602 meets the preset evaluation rule may be determined, and thus the responsiveness of the large language model 602 may be determined as being at first level 606. If yes, a first evaluation information 406 indicating that the large language model 602 does not meet the preset evaluation rule may be determined, and thus the responsiveness of the large language model 602 may be determined as being at second level 608.

According to the embodiments of the present disclosure, in evaluating a single large language model, the performance of the large language model may be directly evaluated through the evaluation based on the preset evaluation rule. By automatically evaluating and grading the response information of the large language model, the efficiency and accuracy of the evaluation may be improved.

The above are only exemplary embodiments, but are not limited to them. They may also include evaluation methods for other large models known in this field, as long as they may accurately evaluate the response capabilities of the large language models.

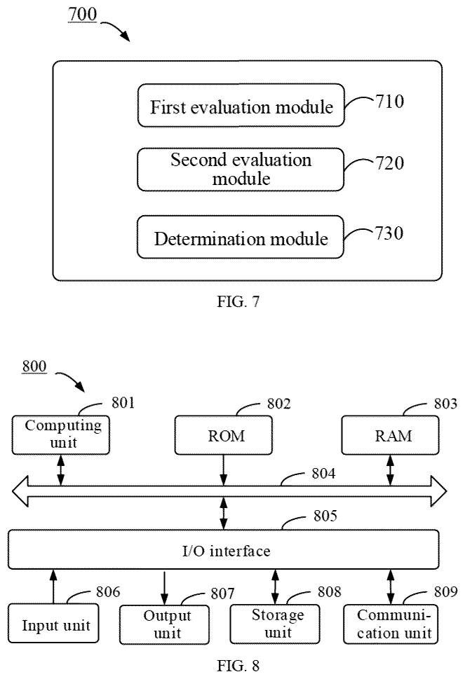

Based on the method for evaluating a large model provided in the present disclosure, the present disclosure also provides an apparatus for evaluating a large model. The apparatus will be described in detail using FIG. 7.

FIG. 7 schematically shows a block diagram of an apparatus for evaluating a large model according to embodiments of the present disclosure.

As shown in FIG. 7, the apparatus 700 for evaluating a large model may include a first evaluation module 710, a second evaluation module 720 and a determination module 730.

The first evaluation module 710 is used to evaluate a response information of each of M large language models for an input instruction based on a preset evaluation rule, so as to obtain a first evaluation information for each response information, where M is a positive integer greater than 1.

The second evaluation module 720 is used to evaluate, in response to the first evaluation information for the M large language models being consistent with each other, the response information in a plurality of evaluation dimensions, so as to obtain a second evaluation information for the response information.

The determination module 730 is used to determine an evaluation result representing a responsiveness of each of the M large language models according to the second evaluation information for the response information.

According to the embodiments of the present disclosure, each large language model is provided with a prompt information for guiding the large language model to respond to the input instruction. The preset evaluation rule includes at least one of: a priority of the prompt information is higher than a priority of the input instruction; or the priority of the input instruction is higher than a priority of the response information.

According to the embodiments of the present disclosure, the first evaluation module 710 may include a first determination unit and a second determination unit.

The first determination unit is used to, for each large language model, determine a first evaluation information indicating that the large language model meets the preset evaluation rule, if the response information is consistent with the prompt information.

The second determination unit is used to, for each large language model, determine a first evaluation information indicating that the large language model does not meet the preset evaluation rule, if the response information is inconsistent with the prompt information.

According to the embodiments of the present disclosure, the second evaluation module 720 may include a matching unit and a third determination unit.

The matching unit is used to perform, based on a prompt information for each evaluation dimension, semantic matching on the response information to obtain a matching information for each evaluation dimension.

The third determination unit is used to determine the second evaluation information for the response information according to the matching information for each evaluation dimension.

According to the embodiments of the present disclosure, the prompt information for each evaluation dimension includes at least one of: a persona customization information, a role customization information, a capability customization information or a style customization information.

According to the embodiments of the present disclosure, the determination module 730 may include a weighting unit, a ranking unit and a fourth determination unit.

The weighing unit is used to weight the second evaluation information for each response information according to a preset weight for each evaluation dimension, so as to obtain a weighted evaluation information for each response information.

The ranking unit is used to rank the M large language models according to the weighted evaluation information for each response information, so as to obtain ranked M large language models.

The fourth determination unit is used to determine the large language models ranked in and before a predetermined ranking as having a first level of responsiveness, and determining other large language models as having a second level of responsiveness, so as to obtain the evaluation result.

According to the embodiments of the present disclosure, the apparatus 700 for evaluating a large model may further include a first determination module and a second determination module.

The first determination module is used to, in response to the first evaluation information for the M large language models being inconsistent, determine the large language model with the first evaluation information indicating that the large language model meets the preset evaluation rule as having a first level of responsiveness.

The second determination module is used to determine the large language model with the first evaluation information indicating that the large language model does not meet the preset evaluation rule as having a second level of responsiveness.

According to the embodiments of the present disclosure, the apparatus 700 for evaluating a large model may further include a third evaluation module, a fourth determination module and a fifth determination module.

The third evaluation module is used to evaluate the response information of the large language model for the input instruction based on the preset evaluation rule, to obtain the first evaluation information.

The fourth determination module is used to determine the large language model as having a first level of responsiveness, if the first evaluation information indicates that the large language model meets the preset evaluation rule.

The fifth determination module is used to determine the large language model as having a second level of responsiveness, if the first evaluation information indicates that the large language model does not meet the preset evaluation rule.

FIG. 8 schematically shows a block diagram of an electronic device suitable for implementing a method for evaluating a large model according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, an electronic device 800 may include a computing unit 801, which may perform various appropriate actions and processing based on a computer program stored in a read-only memory (ROM) 802 or a computer program loaded from a storage unit 808 into a random access memory (RAM) 803. Various programs and data required for the operation of the electronic device 800 may be stored in the RAM 803. The computing unit 801, the ROM 802 and the RAM 803 are connected to each other through a bus 804. An input/output (I/O) interface 805 is further connected to the bus 804.

Various components in the electronic device 800 are connected with I/O interface 805, including an input unit 806, such as a keyboard, a mouse, etc.; an output unit 807, such as various types of displays, speakers, etc.; a storage unit 808, such as a magnetic disk, an optical disk, etc.; and a communication unit 809, such as a network card, a modem, a wireless communication transceiver, etc. The communication unit 809 allows the electronic device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include but are not limited to a central processing unit (CPU), a graphics processing unit (GPU), various specialized artificial intelligence (AI) computing chips, various computing units running machine learning model algorithms, a digital signal processor (DSPs), and any appropriate processor, controller, microcontroller, and so on. The computing unit 801 may perform the various methods and processes described above, such as the method of evaluating a large model. For example, in some embodiments, the method of evaluating a large model may be implemented as a computer software program that is tangibly contained on a machine-readable medium, such as a storage unit 808. In some embodiments, part or all of a computer program may be loaded and/or installed on the electronic device 800 via the ROM 802 and/or the communication unit 809. When the computer program is loaded into the RAM 803 and executed by the computing unit 801, one or more steps of the method of evaluating a large model described above may be performed. Alternatively, in other embodiments, the computing unit 801 may be configured to perform the method of evaluating a large model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described herein may be implemented on a computer including a display device (for example, a CRT (cathode ray tube) or LCD (liquid crystal display) monitor) for displaying information to the user; and a keyboard and a pointing device (for example, a mouse or a trackball), through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server. The server may also be a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for evaluating a large model, comprising:
evaluating a response information of each of M large language models for an input instruction based on a preset evaluation rule, so as to obtain a first evaluation information for each response information, where M is a positive integer greater than 1;
evaluating, in response to the first evaluation information for the M large language models being consistent with each other, each response information in a plurality of evaluation dimensions, so as to obtain a second evaluation information for each response information; and
determining an evaluation result representing a responsiveness of each of the M large language models, according to the second evaluation information for each response information.

2. The method of claim 1, wherein each large language model is provided with a prompt information for guiding the large language model to respond to the input instruction; and
wherein the preset evaluation rule comprises at least one of:
a priority of the prompt information is higher than a priority of the input instruction; or
the priority of the input instruction is higher than a priority of the response information.

3. The method of claim 2, wherein the evaluating a response information of each of M large language models for an input instruction based on a preset evaluation rule to obtain a first evaluation information for each response information comprises: for each large language model,
determining a first evaluation information indicating that the large language model meets the preset evaluation rule, if the response information is consistent with the prompt information; and
determining a first evaluation information indicating that the large language model does not meet the preset evaluation rule, if the response information is inconsistent with the prompt information.

4. The method of claim 1, wherein the evaluating each response information in a plurality of evaluation dimensions to obtain a second evaluation information for each response information comprises: for each response information,
performing, based on a prompt information for each evaluation dimension, semantic matching on the response information to obtain a matching information for each evaluation dimension; and
determining the second evaluation information for the response information according to the matching information for each evaluation dimension.

5. The method of claim 4, wherein the prompt information for each evaluation dimension comprises at least one of: a persona customization information, a role customization information, a capability customization information or a style customization information.

6. The method of claim 1, wherein the determining an evaluation result representing a responsiveness of each of the M large language models, according to the second evaluation information for each response information comprises:
weighting the second evaluation information for each response information according to a preset weight for each evaluation dimension, so as to obtain a weighted evaluation information for each response information;
ranking the M large language models according to the weighted evaluation information for each response information, so as to obtain ranked M large language models; and
determining the large language models ranked in and before a predetermined ranking as having a first level of responsiveness, and determining other large language models as having a second level of responsiveness, so as to obtain the evaluation result.

7. The method of claim 1, further comprising:
in response to the first evaluation information for the M large language models being inconsistent, determining the large language model with the first evaluation information indicating that the large language model meets the preset evaluation rule as having a first level of responsiveness; and
determining the large language model with the first evaluation information indicating that the large language model does not meet the preset evaluation rule as having a second level of responsiveness.

8. The method of claim 1, further comprising:
evaluating the response information of the large language model for the input instruction based on the preset evaluation rule, to obtain the first evaluation information;
determining the large language model as having a first level of responsiveness, if the first evaluation information indicates that the large language model meets the preset evaluation rule; and
determining the large language model as having a second level of responsiveness, if the first evaluation information indicates that the large language model does not meet the preset evaluation rule.

9. An electronic device, comprising:
one or more processors; and
a memory configured to store one or more computer programs,
wherein the one or more processors are configured to execute the one or more computer programs to:
evaluate a response information of each of M large language models for an input instruction based on a preset evaluation rule, so as to obtain a first evaluation information for each response information, where M is a positive integer greater than 1;
evaluate, in response to the first evaluation information for the M large language models being consistent with each other, each response information in a plurality of evaluation dimensions, so as to obtain a second evaluation information for each response information; and
determine an evaluation result representing a responsiveness of each of the M large language models, according to the second evaluation information for each response information.

10. The electronic device of claim 9, wherein each large language model is provided with a prompt information for guiding the large language model to respond to the input instruction; and
wherein the preset evaluation rule comprises at least one of:
a priority of the prompt information is higher than a priority of the input instruction; or
the priority of the input instruction is higher than a priority of the response information.

11. The electronic device of claim 10, wherein the one or more processors are further configured to: for each large language model,
determine a first evaluation information indicating that the large language model meets the preset evaluation rule, if the response information is consistent with the prompt information; and
determine a first evaluation information indicating that the large language model does not meet the preset evaluation rule, if the response information is inconsistent with the prompt information.

12. The electronic device of claim 9, wherein the one or more processors are further configured to: for each response information,
perform, based on a prompt information for each evaluation dimension, semantic matching on the response information to obtain a matching information for each evaluation dimension; and
determine the second evaluation information for the response information according to the matching information for each evaluation dimension.

13. The electronic device of claim 12, wherein the prompt information for each evaluation dimension comprises at least one of: a persona customization information, a role customization information, a capability customization information or a style customization information.

14. The electronic device of claim 9, wherein the one or more processors are further configured to:
weight the second evaluation information for each response information according to a preset weight for each evaluation dimension, so as to obtain a weighted evaluation information for each response information;
rank the M large language models according to the weighted evaluation information for each response information, so as to obtain ranked M large language models; and
determine the large language models ranked in and before a predetermined ranking as having a first level of responsiveness, and determining other large language models as having a second level of responsiveness, so as to obtain the evaluation result.

15. The electronic device of claim 9, wherein the one or more processors are further configured to:
in response to the first evaluation information for the M large language models being inconsistent, determine the large language model with the first evaluation information indicating that the large language model meets the preset evaluation rule as having a first level of responsiveness; and
determine the large language model with the first evaluation information indicating that the large language model does not meet the preset evaluation rule as having a second level of responsiveness.

16. The electronic device of claim 9, wherein the one or more processors are further configured to:
evaluate the response information of the large language model for the input instruction based on the preset evaluation rule, to obtain the first evaluation information;
determine the large language model as having a first level of responsiveness, if the first evaluation information indicates that the large language model meets the preset evaluation rule; and
determine the large language model as having a second level of responsiveness, if the first evaluation information indicates that the large language model does not meet the preset evaluation rule.

17. A computer readable storage medium storing computer programs or instructions, wherein the computer programs or instructions, when executed by a processor, cause the processor to:
evaluate a response information of each of M large language models for an input instruction based on a preset evaluation rule, so as to obtain a first evaluation information for each response information, where M is a positive integer greater than 1;
evaluate, in response to the first evaluation information for the M large language models being consistent with each other, each response information in a plurality of evaluation dimensions, so as to obtain a second evaluation information for each response information; and
determine an evaluation result representing a responsiveness of each of the M large language models, according to the second evaluation information for each response information.

18. The computer readable storage medium of claim 17, wherein each large language model is provided with a prompt information for guiding the large language model to respond to the input instruction; and
wherein the preset evaluation rule comprises at least one of:
a priority of the prompt information is higher than a priority of the input instruction; or
the priority of the input instruction is higher than a priority of the response information.

19. The computer readable storage medium of claim 18, wherein the computer programs or instructions are further configured to cause the processor to: for each large language model,
determine a first evaluation information indicating that the large language model meets the preset evaluation rule, if the response information is consistent with the prompt information; and
determine a first evaluation information indicating that the large language model does not meet the preset evaluation rule, if the response information is inconsistent with the prompt information.

20. The computer readable storage medium of claim 17, wherein the computer programs or instructions are further configured to cause the processor to: for each response information,
perform, based on a prompt information for each evaluation dimension, semantic matching on the response information to obtain a matching information for each evaluation dimension; and
determine the second evaluation information for the response information according to the matching information for each evaluation dimension.
